(19) United States
(12) Patent Application Publication
(10) Pub. No.: US 2001/0005844 A1
(43) Pub. Date: Jun. 28, 2001

(54) Peripheral unit and computer system

(75) Inventor: Takero Kobayashi, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 09/746,220

(22) Filed: Dec. 26, 2000

(30) Foreign Application Priority Data
Dec. 27, 1999 (JP) 11-371561

(51) Int. Cl. G06F 7/00

(52) U.S. Cl. 707/1

(57) ABSTRACT

PC 1, PC 2, HDD, and NIC are connected to each other via a bus cable. In addition, PC 1 and PC 2 both include functions for controlling the HDD and NIC, and can operate as initiators of the HDD and NIC. On the other hand, the HDD and NIC both operate as target devices of the PC 1 and PC 2. According to the present invention, a function for switching a function provided for each of the PC 1 and PC 2 that are initiators is incorporated in the HDD and NIC that are target devices of the invention.

### CROSS-REFERENCE TO RELATED APPLICATIONS

This application is based upon and claims the benefit of priority from the prior Japanese Patent Application No. 11-371561, filed Dec. 27, 1999, the entire contents of which are incorporated herein by reference.

### BACKGROUND OF THE INVENTION

The present invention relates to a peripheral unit and a computer system for applying the unit that receives control from at least one or more control units connected via a bus. In particular, the present invention relates to a peripheral unit and a computer system for applying the unit that are capable of switching a function provided for each control unit.

The IEEE 1394 specifies a fast serial bus that connects information units each other, and performs data exchange. It is expected to make uses for connecting a digital video camera or HDD (magnetic disk) or MO (magneto-optical disk) to a PC (personal computer) or to connect a digital broadcast receiving unit and a digital television. IEEE 1394 based protocols such as SBP 2 or AVC are specified in order to implement connection between these units.

In the meantime, a peripheral unit such as NDD connected to the IEEE 1394 bus is generally controlled in accordance with SBP 2 protocols. Here, let us consider a state in which a plurality of PCs and HDDs are connected to the IEEE 1394 bus. The SBP 2 specifies that an IEEE 1394 bus is employed to control a SCSI device.

The SBP 2 protocol specifies that one peripheral unit corresponds to a plurality of initiators (control side). However, this protocol fails to specify required data exchange between the initiators. From this fact, the following problem occurs.

For example, as shown in FIG. 1, in the case where an HDD is utilized from two initiators, PC1 and PC2, at the point when the HDD is first connected, the PC1 and PC2 acquire file system information (e.g., FAT:File Allocation Table) on the HDD, respectively, and manages the same. Here, in the case where the PC1 writes any file data into the HDD, the file system is updated inside of the PC1 and on the HDD. However, in the PC2, as long as the file system on the HDD is acquired again, the writing is not recognized. Therefore, in the case where the PC2 writes another file data, there has been a possibility that the data on the HDD may be destroyed.

In order to avoid such problem, the SBP 2 is provided with a mode called a single initiator that limits the number of initiators for issuing a control command to one. (In contrast, a mode for enabling control from a plurality of initiators is called multiple initiator).

However, as described previously, only a case in which data is destroyed occurs with respect to write processing. With respect to readout processing, there is only a possibility that an initiator which does not recognize change due to writing reads out invalid data. Therefore, in many cases, there is a great advantage that at least readout is enabled. However, in the SBP 2, there is provided no mechanism that a write command is discriminated from a readout command. Thus, it has been impossible to provide settings for one initiator to enable write and readout operations, and for another initiator to enable only readout operation.

In addition, in FIG. 1, there is shown an example when an NIC (Network Interface Card) as well as HDD is connected. Which of the PC1 and PC2 acquires a privilege of this NIC is basically determined depending on the principle of “first comes, first served”. Thus, there has been a problem, for example, that a system cannot always be activated in a user desired state.

Further, some IEEE 1394 devices provide a plurality of functions to initiators (multiple function node). For example, the IEEE 1394 device shown in FIG. 2 provides two functions, i.e., a HDD function and a CD ROM function to PC1 and PC2 that are initiators. However, it has been impossible to switch a function provided for only PC1 to enable use of the HDD function, and for only PC2 to enable use of the CD ROM function.

### BRIEF SUMMARY OF THE INVENTION

It is an object of the present invention to provide a peripheral unit and a computer system for applying the unit that are capable of switching a function provided for each control unit.

In order to achieve the aforementioned object, according to the present invention, there is provided a peripheral unit adopted to switch a function provided for each initiator utilized itself on the peripheral unit, the peripheral unit therefor receiving controls from at least one or more control units connected to a bus comprises means for switching a function for each of the control units.

In the peripheral unit according to the present invention, it is possible to change a function provided for each of a plurality of initiators that exist in the bus.

In addition, according to the present invention, there is provided a peripheral unit for receiving controls from at least one or more control units connected to a bus, the peripheral unit comprising means for setting whether or not to provide a function for each of the control units.

In the peripheral unit according to the present invention, it is possible to receive control from only an arbitrary initiator that exists on a bus, for example.

The peripheral unit according to the present invention is featured to be a storage unit that always receives requests from all control units with respect to a readout command, and receives only a request from one control unit specified in accordance with a temporarily defined rule with respect to a write command.

In the storage unit according to the present invention, only one initiator temporarily enables writing, whereby a plurality of initiators performs writing without sharing a file system. This prevents data written by any initiator from being destroyed by writing of another initiator.

The peripheral unit according to the present invention is featured to be a communication device that receives only a request from one control unit specified in accordance with a temporarily defined rule.

In the communication device according to the present invention, only one initiator temporarily enables use of the communication device, thereby preventing the breakage of communication protocols due to the access from a plurality of initiators.

According to the present invention, there is provided a peripheral unit with its multiple functions, the peripheral unit being connected to at least one or more control units via an IEEE 1394 bus, wherein the peripheral unit has a control function implemented as one of the functions controlled from the control units, the control function executing the operation setting of a function other than the functions of the peripheral unit for each of the control units.

In the peripheral unit according to the present invention, it is possible to implement control for a function controlled in accordance with a specified protocol, the control incapable of being achieved under the specified protocol.

In addition, according to the peripheral unit of the present invention, the control function comprises: means for acquiring identification information for uniquely identifying the control unit; and means for, when there occurs a change with topology of the IEEE 1394 bus, employing the acquired identification information, thereby continuously reflecting operation settings prior to change of topology after the topology has been changed.

In the peripheral unit according to the present invention, even in the case where there occurs a change with topology of the IEEE 1394 bus, the operation settings prior to change of topology can be transferred to the change of topology, thus making it possible to improve the performance of the entire system.

According to the present invention, a function provided for each initiator utilized itself on the peripheral unit is switched, thus making it possible to change a function provided for each of a plurality of initiators that exist in a bus.

In addition, in the case of a peripheral unit with its multiple functions, the peripheral unit being connected to the IEEE 1394 bus, a control function for executing operation settings of a function other than the functions of the peripheral unit for each initiator is implemented as one of the multiple functions, thereby making it possible to implement control for a function controlled in accordance with a specified protocol, the control incapable of being implemented in accordance with the specified protocol.

Further, in the case where there occurs a change with topology of the IEEE 1394 bus, the operation settings prior to change of topology is transferred to the change of topology, thus making it possible to improve the performance of the entire system.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a first view for illustrating a problem when a conventional peripheral unit is controlled by a plurality of initiators;

FIG. 2 is a second view for illustrating a problem when a conventional peripheral unit is controlled by a plurality of initiators;

FIG. 3 is a view showing a connection example of a computer system in a first embodiment of the present invention;

FIG. 4 is a view showing an example of connection between a PC and an IEEE 1394 peripheral unit according to a second embodiment of the present invention;

FIG. 5 is a view showing a configuration of the IEEE 1394 peripheral unit according to the second embodiment of the present invention;

FIG. 6 is a view showing a simplified example of ConfigROM provided by the IEEE 1394 peripheral unit according to the second embodiment of the present invention;

FIG. 7 is a first view for illustrating an operation when the IEEE 1394 peripheral unit and a plurality of PCs are connected to each other via the IEEE 1394 bus according to the second embodiment of the present invention;

FIG. 8 is a second view for illustrating an operation when the IEEE 1394 peripheral unit and a plurality of PCs are connected to each other via the IEEE 1394 bus according to the second embodiment of the present invention; and

FIG. 9 is a third view for illustrating an operation when the IEEE 1394 peripheral unit and a plurality of PCs are connected to each other via the IEEE 1394 bus according to the second embodiment of the present invention.

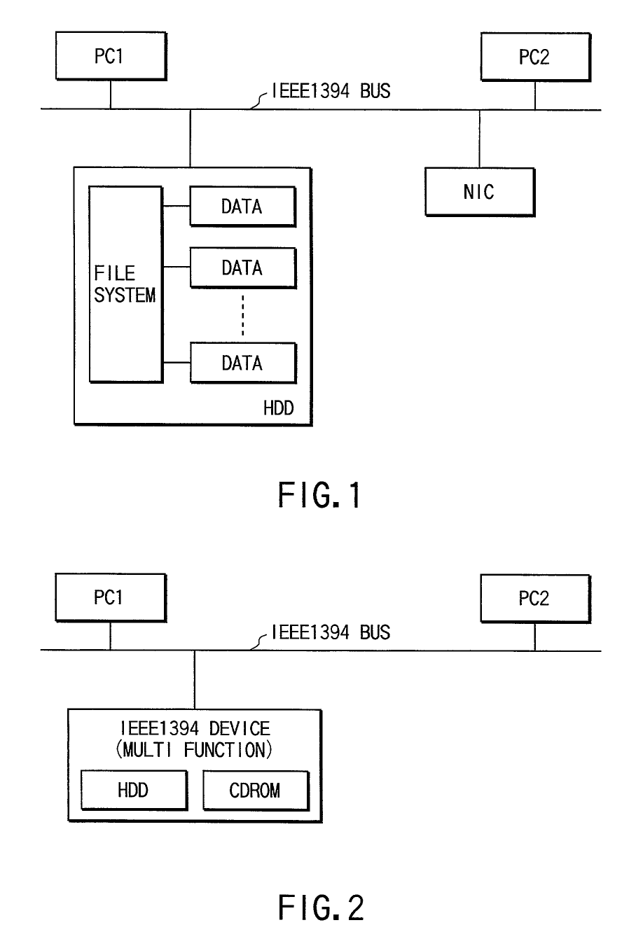

### DETAILED DESCRIPTION OF THE INVENTION

Hereinafter, embodiments of the present invention will be described with reference to the accompanying drawings.

### First Embodiment

Now, a first embodiment of the present invention will be described here.

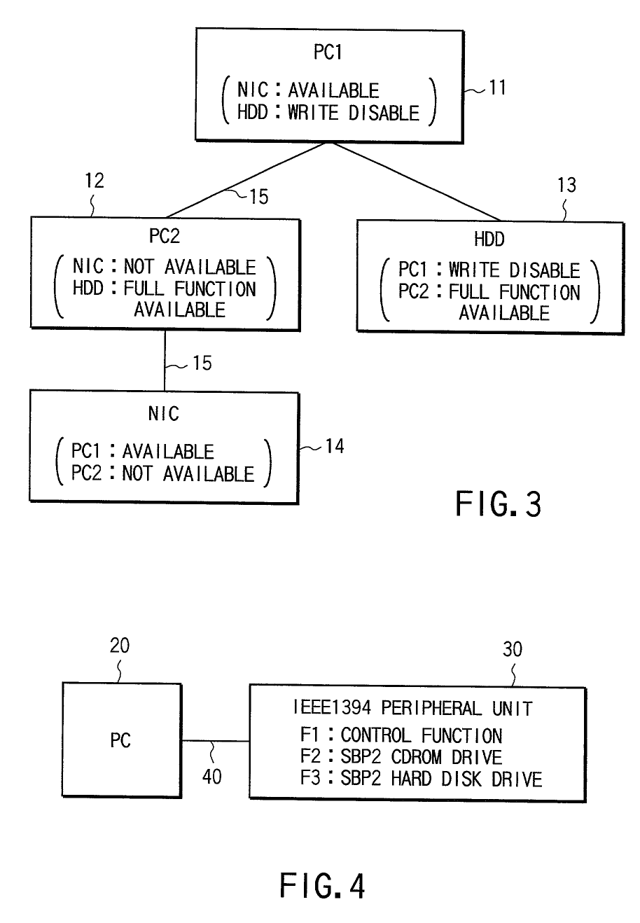

FIG. 3 is a view showing a connection example of a computer system in the first embodiment of the present invention.

As shown in FIG. 3, in this computer system according to the first embodiment, a PC (personal computer) 1 (11), a PC (personal computer) 2 (12), a HD (magnetic disk) 13, and a NIC (network interface card) 14 are connected to each other via a bus cable 15.

The PC 1 (11) and PC 2 (12) both have functions for controlling the HDD 13 and NIC 14, and can operate as an initiator of the HDD 13 and NIC 14. On the other hand, the HDD 13 and NIC 14 both operate as target devices of the PC 1 (11) and PC 2 (12). The present invention is characterized in that the HDD 13 and NIC 14 that are target devices switch the functions provided for each of the PC 1 (11) and PC 2 (12) that are initiators. A detailed description of this switching function will be given below.

As described previously, the PC 1 (11) and PC 2 (12) both have functions for controlling the HDD 13 and NIC 14 that are connected to bus 15. On the other hand, the HDD 13 sets functions provided for the PC 1 (11) and PC 2 (12) that utilize their own functions in accordance with predetermined procedures. The predetermined procedures include transmitting control information concerning use of their own functions from the PC 1 (11) and PC 2 (12), and setting the functions provided based on the control information. Alternatively, the control information may be set preliminarily on the HDD 13 and the NIC 14 b any other means. For example, the control information may be set on the device by connecting one of PCs and one of the 1394 devices in one to one correspondence. The same procedure may be repeated by the number of the PCs and the devices.

In this first embodiment, the initiator that can use the write function of the HDD 13 is limited to the PC 2 (12). In this manner, the PC 2 (12) can use all functions such as data read/write function of the HDD 13. The PC 1 (11) enables a data read function of the HDD 13, but disables a write function with data modification. A write processing request from the PC 1 (11) is not implemented by the HDD 13, and fails.

Similarly, the NIC 14 have only one initiator that utilizes its own functions in accordance with predetermined procedures. In this first embodiment, the initiator that can use the functions of the NIC 14 is limited to PC1 (11). In this manner, the PC 1 (11) can use a network connection function of the NIC 14, but the PC 2 (12) cannot use the network connection function of the NIC 14. Thus, a request for use from the PC 2 (12) is not implemented by the NIC 14, and fails.

In this manner, a function provided for each of the PC 1 (11) and PC 2 (12) that are initiators is switched to the HDD 13 and NIC 14 that are target devices or means for setting whether or not to provide a function is incorporated, thereby making it possible to implement a control that cannot be achieved in a bus protocol.

The HDD 13 receives only a write command from one initiator specified in accordance with predetermined procedures for one period (this HDD always receives a readout command). Thus, even in the case where settings are conducted so as to provide a write function to a plurality of initiators, data written by any one initiator is prevented from being destroyed by writing of another initiator.

Similarly, the NIC 14 receives only a command from one initiator specified in accordance with predetermined procedures for one period. In this manner, even if settings are conducted so that a plurality of initiators are available, a communication protocol is prevented from being destroyed due to the access from a plurality of initiators.

### Second Embodiment

Now, a second embodiment of the present invention will be described here.

This second embodiment describes an example in which the present invention is applied to the IEEE 1394 peripheral unit connected to the IEEE 1394 bus.

FIG. 4 is a view showing an example of connection between a PC and the IEEE 1394 peripheral unit.

As shown in FIG. 4, this IEEE 1394 peripheral unit 30 is connected to a variety of initiators such as PC 20 via an IEEE 1394 cable 40. Over this IEEE 1394 bus, there are provided three functions (control function (F1), SBP 2 CD ROM drive (F2), and SBP 2 hard disk drive (F3)). This control function (F1) executes operation settings of two functions other than its own functions for each initiator. This IEEE 1394 peripheral unit 30 is characterized in that this control function (F1) is incorporated as one of the multiple functions.

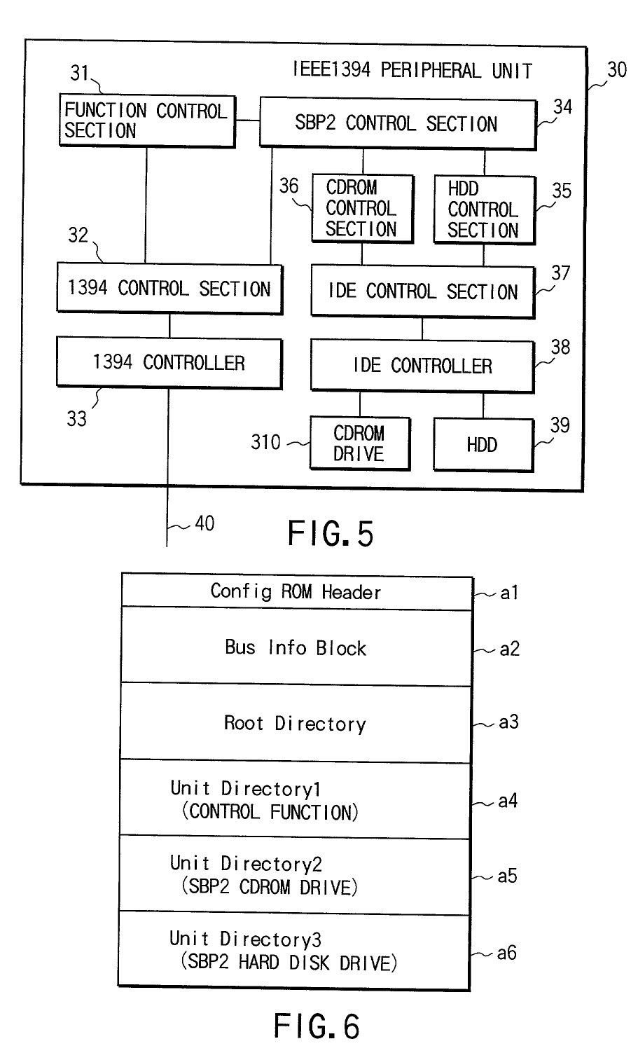

FIG. 5 is a view showing a configuration of this IEEE 1394 peripheral unit 30.

As shown in FIG. 5, the IEEE 1394 peripheral unit 30 comprises a function control section 31, a 1394 control section 32, a 1394 controller 33, a SBP 2 control section 34, a HDD control section 35, a CD ROM control section 36, an IDE control section 37, an IDE controller 38, a HDD 39, and a CD ROM drive 40.

The function control section 31 provides a control function (F1) of the same unit over the IEEE 1394 bus, and executes operation settings or the like of the SBP 2 control section 34. The 1394 control section 32 controls the 1394 controller 33, and intervenes data exchange processing between each of the function control section 31 and SBP 2 control section 34 and an initiator to be performed via the IEEE 1394 cable 40.

The 1394 controller 33 is controlled by the 1394 control section 32, and executes data exchange processing performed via the IEEE 1394 cable 40. The SBP 2 control section 34 provides two SBP 2 functions, i.e., the CD ROM drive (F2) and HDD (F3) of the same unit.

The HDD control section 35 executes processing given by the SBP 2 control section 34 for the HDD 39 via a IDE control section 37. The CD ROM control section 36 executes processing given by the SBP 2 control section 34 for the CD ROM drive 310 via the IDE control section 37.

The IDE control section 37 operates the HDD 39 and the CD ROM drive 310 via the IDE controller 38. The IDE controller 38 is controlled by the IDE control section 37, and executes control/data exchanging relevant to the HDD 39 and CD ROM drive 310.

The HDD 39 and CD ROM drive are external storage devices, and are connected to the IDE controller 38.

FIG. 6 is a view showing a simplified example of ConfigROM provided by this IEEE 1394 peripheral unit 30.

a1 denotes a ConfigROM header in which the side of the ConfigROM or the like is stored.

a2 denotes a Bus Info Block in which information on the performance or functions of this device is stored.

a3 denotes a Root Directory in which information on address offsets of the Unit Directory of a4 to a6 is stored.

a4 to a6 each denote a Unit Directory. a4 stores information for identifying and using a control function. a5 denotes a function for SBP 2, and provides a CD ROM function. a6 denotes a function for SBP 2, and provides a HDD function.

Now, an operation of this IEEE 1394 peripheral unit 30 having such configuration will be described here.

When the IEEE 1394 peripheral unit 30 is connected via an initiator such as PC 20 and the IEEE 1394 cable 40, as shown in FIG. 4, the ConfigROM shown in FIG. 6 is disclosed over the IEEE 1394 bus. The PC 20 incorporates in advance a function control program targeted for the control function (F1) of the IEEE 1394 peripheral unit 30 and the SBP 2 control program. These programs execute an exchange between control signal and data via the IEEE 1394 cable 40. This function control program is a sort of a dedicated driver for reading the control information contained in the unit directory shown in FIG. 4. The control information includes a protocol such as a SBP2 protocol controlling the device.

On the other hand, in the IEEE 1394 peripheral unit 30, the function control section 31 acquires control information from the PC 20, and executes operation settings of the SBP 2 control section 34. This control information pertains to enable or disable of the SBP2 CDROM drive and the SBPS HDD, for example. The SBP2 control section 34 switches operation between the SBP 2 CD ROM drive function and SBP 2 hard disk drive function based on the operation settings provided by the function control section 31.

That is, the PC 20 can use the SBP 2 CD ROM drive function and the SBP 2 hard disk drive function while the control information transmitted by the function control program is reflected.

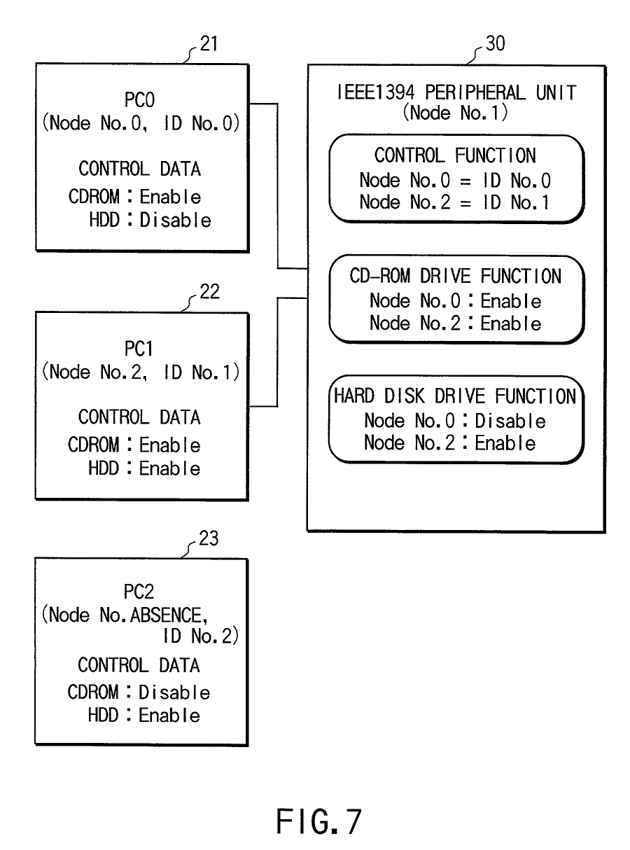

Now, an operation when this IEEE 1394 peripheral unit and a plurality of PCs are connected to each other via the IEEE 1394 bus will be described here with reference to FIG. 7 to FIG. 9.

As shown in FIG. 7, assume that the PC 0 (21) and PC 1 (22) are connected to the IEEE 1394 peripheral unit 30. The PC 0 (21) and PC 1 (22) incorporate a function control program for exchanging a control function that is one of the functions of the IEEE 1394 peripheral unit 30 and data. The control information set in advance in the PC using the control program is transmitted to the IEEE 1394 peripheral unit 30.

For example, in the PC 0 (21), a setting is provided so as to disable the CD ROM function of the IEEE 1394 peripheral unit 30. The control function stores an ID for uniquely identifying the PC 0 (21), and associates given control information with this ID. The acquired control information is associated with a node ID of the current IEEE 1394 bus, and is set as information for switching the controls of the CD ROM drive function and the HDD function that are incorporated in the IEEE 1394 peripheral unit 30. More specifically, according to IEEE 1394 specification, GUID (Global Unique ID; which corresponds to ID No. in the embodiment) is present for each node (initiator) on a bus address space. A control packet sent from each node includes a Node ID. This Node ID is dynamically changed upon the topology change.

While these items of information are reflected, in the case where the PC 0 (21) transmits login processing for the CD ROM drive function and HDD function, the login relevant to the CD ROM drive succeeds, but the login relevant to the HDD fails, and is disabled. This almost applies to the PC 1 (22). In the case where this PC 1 (22) transmits login processing for the CD ROM drive function and HDD function, the login of the CD ROM drive and HDD both succeeds.

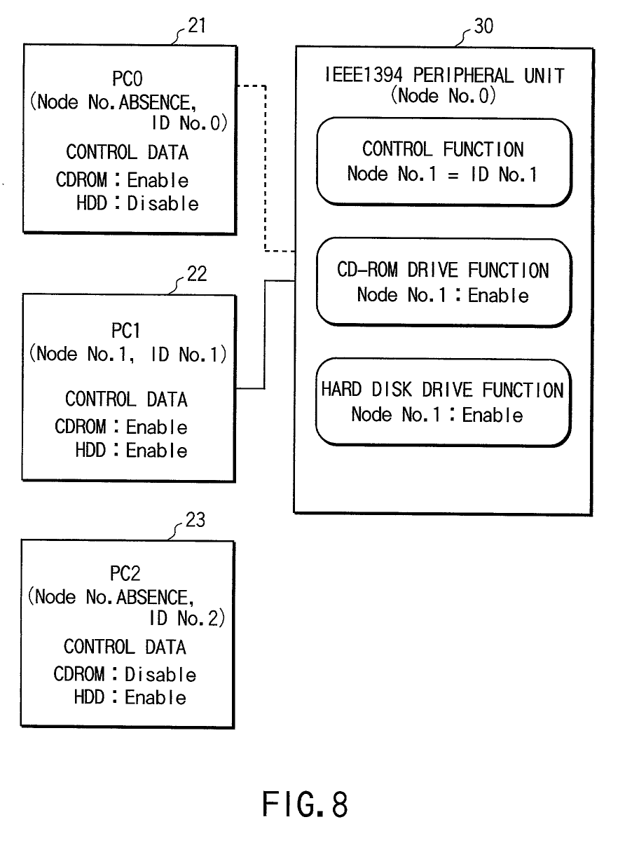

Here, let us consider an operation when the PC 0 (21) is released from the IEEE 1394 bus as shown in FIG. 8.

In this case, topology of the IEEE 1394 bus changes. The PC1 (22) function control program detects this topology change, and attempts processing for registering set information again relevant to the IEEE 1394 peripheral unit 30. In the case where the PC 1 (22) requests login processing, the CD ROM function and HDD function check whether or not set information from the PC 1 (22) has been registered again. When the information has been re-registered, login processing is proceeded in accordance with the relevant information. On the other hand, if the re-registration has not been completed, an ID of the PC 1 (22) is acquired, and it is checked whether or not set information has been registered before change of topology. Here, the IEEE 1394 peripheral unit 30 is used before change of topology. Thus, the relevant information is reflected on login processing. In addition, a correspondence between the set information and the ID is not obtained, the default settings for each function are reflected. However, reconnect processing of SBP 2 is accepted in excess of these limitations. In other words, this reflection does not affect a reconnect process (GUID is obtained again since the Node ID is changed upon topology change+) specified in the SBP2 process.

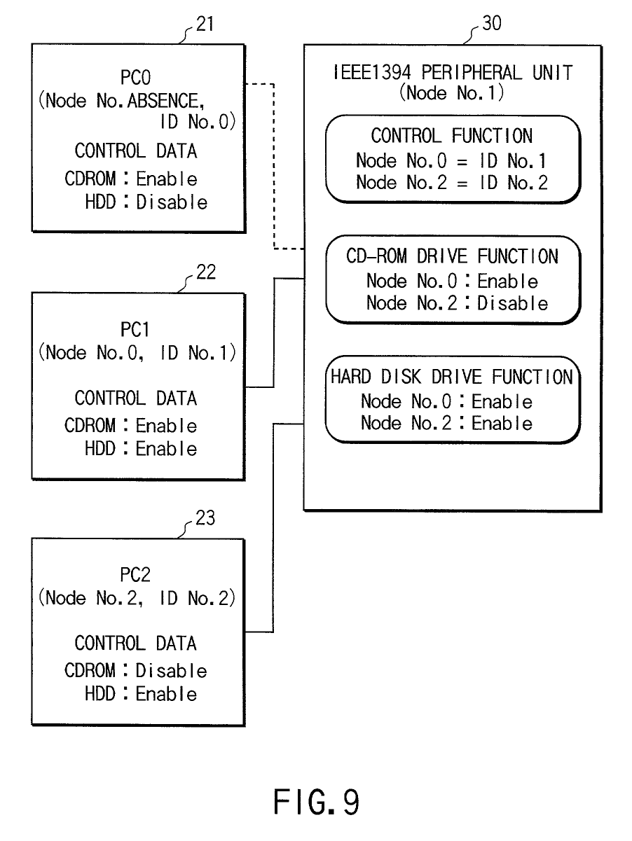

In FIG. 9, there is shown a case in which the PC 2 (23) is further connected to the IEEE 1394 bus.

The PC 2 (23) also incorporates a function control program for using a control function of the IEEE 1394 peripheral unit 30, and transmits control information to the IEEE 1394 peripheral unit 30. Then, the IEEE 1394 peripheral unit 30 switches operation between the CD ROM drive function and the HDD function based on the control information and the current node number from the PC 1 (22) and PC 2 (23).

In this manner, the peripheral unit 30 with its multiple functions connected to the IEEE 1394 bus has a function for executing operation settings of another function for each initiator as one of the multiple functions, thereby making it possible to implement control that cannot be achieved in accordance with a bus protocol.

In addition, in the case where a change occurs with topology of the IEEE 1394 bus, the operation settings prior to change of topology are transferred to change of topology, thus making it possible to the performance of the entire system.

In this second embodiment, although there is shown an example when operation settings caused by re-registration processing of set information from the initiator are transferred after change of topology, it is effective that the IEEE 1394 peripheral unit 30 itself judges whether or not an initiator using its own function exists on the IEEE 1394 before change of topology, and then, the operation settings are transferred. Further, the IEEE 1394 peripheral unit 30 itself actively acquires the set information possessed by an initiator whose presence has been checked so that the operation settings may be transferred by using the acquired information.

Note that in the above embodiment, the initiators and the peripheral devices are connected through a bus. However, the present invention is not limited to the above embodiments. For example, the present invention can be applied to the initiators and the device which are connected through a communication circuit such as Bluetooth.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A peripheral unit to be controlled by at least one or more control units, comprising:
means for identifying at least one of control units each connected to and controlling the peripheral unit through a communication circuit;
means for receiving a control command issued from at least one of the control units; and
means for assigning, in response to the control command, a function to be provided to the control unit in accordance with the identification by the identifying unit.

2. A peripheral unit to be controlled by at least one or more control units, comprising:
means for identifying at least one of control units each connected to and controlling the peripheral unit through a communication circuit;
means for receiving a control command issued from at least one of the control units;
means for assigning, in response to the control command, a function to be provided to the control unit in accordance with the identification by the identifying unit; and
means for setting presence or absence of the function for each of said control units.

3. A peripheral unit according to claim 1, wherein said peripheral unit always receives requests from all the control units with respect to a readout command, and receives only a request from one control unit specified in accordance with a temporarily predetermined rule with respect to a write command.

4. A peripheral unit according to claim 2, wherein said peripheral unit always receives requests from all the control units with respect to a readout command, and receives only a request from one control unit specified in accordance with a temporarily predetermined rule with respect to a write command.

5. A peripheral unit according to claim 1, wherein said peripheral unit receives only a request from one control unit specified in accordance with a temporarily predetermined rule.

6. A peripheral unit according to claim 2, wherein said peripheral unit receives only a request from one control unit specified in accordance with a temporarily predetermined rule.

7. A peripheral unit with its multiple functions connected to at least one or more control units via an IEEE 1394 bus, said peripheral unit comprising: a control function implemented as one of the functions controlled by said control units, the control function executing operation settings of a function other than those of the peripheral unit itself for each of said control units.

8. A peripheral unit according to claim 7, wherein said control function comprises: means for acquiring identification information for uniquely identifying said control units; and means for, when a change occurs with topology of said IEEE 1394 bus, using said acquired identification information, thereby causing operation settings prior to change of topology to be continuously reflected after change of topology.

9. A peripheral unit according to claim 7, wherein said control function comprises: means for acquiring identification information for uniquely identifying said control units; means for, when a change occurs with topology of said IEEE 1394 bus, judging whether or not the control unit identified by said acquired identification information exists on said IEEE 1394 bus; and means for causing operation settings prior to change of topology with respect to a control unit judged to be present by said judgment means to be continuously reflected after change of topology.

10. A peripheral unit according to claim 7, wherein said control function comprises: means for acquiring identification information for uniquely identifying said control units; means for, when a change occurs with topology of said IEEE 1394 bus, judging whether or not the control unit identified by said acquired identification information exists on said IEEE 1394 bus; means for acquiring control information concerning operation settings of said another function possessed by the control unit judged to be present by said judgment means; and means for using said acquired control information, thereby executing operation settings of said another function associated with the control unit that possesses the control information.

11. A peripheral unit for receiving controls from at least one or more control units connected to each other via a bus, said peripheral unit comprising:
a first control unit for setting whether or not a function is provided for each of said control units; and
a second control unit for switching a function provided for each of said control units in accordance with whether or not to provide the function set by said first control unit.

12. A peripheral unit according to claim 11, wherein said peripheral unit is a storage device.

13. A peripheral unit according to claim 12, wherein said peripheral unit always receives requests from all the control units with respect to a readout command, and receives only a request from one control unit specified in accordance with a temporarily predetermined rule with respect to a write command.

14. A peripheral unit according to claim 11, wherein said peripheral unit receives only a request from one control unit specified in accordance with a temporarily predetermined rule.

15. A computer system, comprising:
at least one or more control units;
a peripheral unit having a plurality of functions controlled by the control units;
a bus for connecting said control unit and said peripheral unit;
wherein said each control unit includes means for notifying a function of said peripheral unit employed by the control unit to said peripheral unit, and said peripheral unit includes means for switching a function provided for each of said control units based on notification from said control units.

16. A computer system, comprising:
at least one or more control units;
a peripheral unit having a plurality of functions controlled by the control units;
a bus for connecting said control unit and said peripheral unit;
wherein said each control unit notifies to said peripheral unit whether or not to use the function of said peripheral unit, and said peripheral unit includes means for setting whether or not a function is provided for each of said control units based on the notification from said control units.
